(19) United States
(12) Patent Application Publication
(10) Pub. No.: US 2022/0321963 A1
(43) Pub. Date: Oct. 6, 2022

(54) METHOD AND APPARATUS FOR VIDEO RECOMMENDATION, AND REFRIGERATOR WITH SCREEN

(71) Applicants: QINGDAO HAIGAO DESIGN & MANUFACTURING CO., LTD., Qingdao, Shandong (CN); HAIER SMART HOME CO., LTD., Qingdao, Shandong (CN)

(72) Inventors: Jian WU, Qingdao, Shandong (CN); Shu ZHOU, Qingdao, Shandong (CN); Zhaojun FEI, Qingdao, Shandong (CN); Zuowei YI, Qingdao, Shandong (CN); Chunhui JIANG, Qingdao, Shandong (CN); Zhiqun FENG, Qingdao, Shandong (CN)

(21) Appl. No.: 17/312,020

(22) PCT Filed: Nov. 12, 2020
(86) PCT No.: PCT/CN2020/128273

§ 371 Date: Jun. 9, 2021

(30) Foreign Application Priority Data
Jun. 3, 2020 (CN) 202010496848.3

(51) Int. Cl. H04N 21/466; H04N 21/45; H04N 21/258; F25D 29/00

(52) U.S. Cl. CPC H04N 21/4668; H04N 21/4667; H04N 21/4532; H04N 21/25891; F25D 29/005; F25D 2400/36

(57) ABSTRACT

The present disclosure relates to the technical field of big data analysis, and discloses a method for video recommendation. The method includes: determining a first reference video according to a watching history of a user; determining a collection of recommended videos according to the first reference video; selecting a second reference video from the collection of recommended videos, where videos not selected in the collection of recommended videos are used as candidate videos; and determining recommended videos according to the similarity between the candidate videos and the second reference video. According to the method, a collection of recommended videos is determined according to a watching history of a user, reference videos are selected from the collection of recommended videos, and then recommended videos are determined according to the reference videos, so that the recommended videos are more customized and targeting, matching user requirements and enabling a better user experience.

### CROSS-REFERENCE TO RELATED APPLICATIONS

The present application is filed on the basis of and claims priority to Chinese Patent Application No. 202010496848.3, filed on Jun. 3, 2020, which is incorporated herein by reference in its entirety.

### TECHNICAL FIELD

The present disclosure relates to the technical field of big data analysis, and more particularly, to a method and an apparatus for video recommendation, and a refrigerator with a screen.

### BACKGROUND

As technology advances, more and more refrigerators are provided with a screen capable of playing videos, and people can watch online movies, cooking tutorial videos, and the like on such an intelligent refrigerator with the screen when doing housework in a kitchen. For a better user experience, the refrigerator for video playing recommends relevant videos to a user according to the watching history of the user.

In implementing embodiments of the present disclosure, it has been found that the prior art is defective at least in that:

in the prior art, video recommendations are classified roughly, and the videos recommended to the user are superfluous and poorly organized, not matching user requirements and leading to a poor user experience.

### SUMMARY

A summary is provided to facilitate a basic understanding of some aspects of the disclosed embodiments. The summary is not a general overview, nor is it intended to identify key/critical elements or to define the scope of the embodiments, but rather as a prelude to the detailed description that follows.

Embodiments of the present disclosure provide a method and an apparatus for video recommendation, and a refrigerator with a screen to solve the technical problem of how to customize video recommendation.

In some embodiments, the method includes:

determining a first reference video according to a watching history of a user;

determining a collection of recommended videos according to the first reference video;

selecting a second reference video from the collection of recommended videos, where videos not selected in the collection of recommended videos are used as candidate videos; and

determining recommended videos according to a similarity between the candidate videos and the second reference video.

In some embodiments, the apparatus includes a processor and a memory storing program instructions, the processor being configured to perform the method for video recommendation as described above when executing the program instructions.

In some embodiments, the refrigerator with the screen includes the apparatus for video recommendation as described above.

The method and the apparatus for video recommendation, and the refrigerator with the screen are advantageous in that: a collection of recommended videos is determined according to a watching history of a user, reference videos are selected from the collection of recommended videos, and then recommended videos are determined according to the reference videos, so that the recommended videos are more customized and targeting, matching user requirements and enabling a better user experience.

The foregoing summary and the following description are exemplary and explanatory only and are not limiting the invention.

### BRIEF DESCRIPTION OF THE DRAWINGS

One or more embodiments are exemplified in the accompanying drawings, and such examples and drawings do not define the scope of the embodiments; like reference signs denote like elements throughout the drawings, and the drawings are not to scale, where:

FIG. 1 is a schematic diagram of a method for video recommendation provided by an embodiment of the present disclosure;

FIG. 2 is a schematic diagram of another method for video recommendation provided by an embodiment of the present disclosure; and

FIG. 3 is a schematic diagram of an apparatus for video recommendation provided by an embodiment of the present disclosure.

### DETAILED DESCRIPTION

A detailed description of the implementation of the embodiments of the disclosure will be provided with reference to the accompanying drawings to facilitate a fuller and clearer understanding of features and technical aspects of the embodiments of the disclosure, and the drawings are included by way of illustration only and are not intended to limit the embodiments of the disclosure. In the following technical description, for an illustrative purpose, a plenty of details are set forth to provide a thorough understanding of the disclosed embodiments. However, one or more embodiments may be practiced without these such details. In other instances, well-known structures and devices may be simplified for the brevity of the drawings.

The terms “first”, “second”, and the like in the description of the embodiments and claims of the present disclosure as well as in the accompanying drawings are used for distinguishing between similar objects and not necessarily for describing a particular order or sequence. It is to be understood that the numerals so used are interchangeable as appropriate for the convenience of the description of the embodiments of the present disclosure. Furthermore, the terms “include” and “have”, as well as any variations thereof, are intended to cover a non-exclusive inclusion.

Unless otherwise indicated, the term “plurality” means two or more.

In the disclosed embodiment, the character “/” indicates that the objects in a context has an “OR” relationship. For example, A/B means A or B.

The term “and/or” describes an associative relationship between objects, indicating three cases of relationships, for example, A and/or B means A, or B, or A and B.

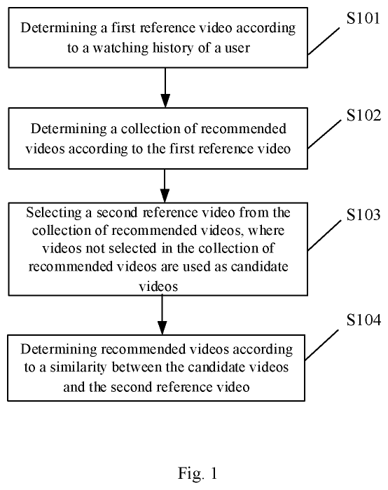

As shown in conjunction with FIG. 1, an embodiment of the present disclosure provides a method for video recommendation, including:

step S101, determining a first reference video according to a watching history of a user;

step S102, determining a collection of recommended videos according to the first reference video;

step S103, selecting a second reference video from the collection of recommended videos, where videos not selected in the collection of recommended videos are used as candidate videos; and

step S104, determining recommended videos according to a similarity between the candidate videos and the second reference video.

According to the method for video recommendation provided by the embodiment herein, a collection of recommended videos is determined according to a watching history of a user, reference videos are selected from the collection of recommended videos, and then recommended videos are determined according to the reference videos, so that the recommended videos are more customized and targeting, matching user requirements and enabling a better user experience.

Optionally, the step of determining a collection of recommended videos according to the first reference video includes: determining a type of recommended videos according to the first reference video; and determining the collection of recommended videos according to the type of recommended videos.

Optionally, the watching history includes a history of a latest video a user watched; or a history of a latest video the user watched for a duration reaching a set threshold value; or a history of a video the user watched most frequently. Accordingly, a video corresponding to the history of a latest video a user watched is determined as the first reference video; a video corresponding to the history of a latest video the user watched for a duration reaching a set threshold value is determined as the first reference video; and s video corresponding to the history of a video the user watched most frequently is determined as the first reference video.

Optionally, the step of determining a type of recommended videos according to the first reference video includes: determining a most frequent type of videos in a set timeframe since the first reference video appears as the type of recommended videos.

Optionally, the step of determining a collection of recommended videos according to the type of recommended videos includes: adding videos corresponding to the type of recommended videos to the collection of recommended videos.

Optionally, the step of selecting a second reference video from the collection of recommended videos includes: selecting a video the user watched for the longest time from the collection of recommended videos as the second reference video, where videos not selected from the collection of recommended videos are used candidate videos; or randomly selecting one video from the collection of recommended videos as the second reference video, where videos not selected from the collection of recommended videos are used candidate videos.

Optionally, the step of determining recommended videos according to a similarity between the candidate videos and the second reference video includes:

acquiring a similarity between each candidate video between the second reference video;

selecting a candidate video with a maximum similarity to the second reference video as a recommended video; or

selecting a candidate video with a minimum similarity to the second reference video as a recommended video; or

selecting a candidate video with a similarity in a set range to the second reference video as a recommended video. Optionally, the step of selecting a candidate video with a similarity in a set range to the second reference video as a recommended video includes: taking a candidate video with a similarity falling within a set interval as a recommended video. The recommended video is obtained and then recommended to the user.

Optionally, the step of acquiring a similarity between each candidate video and the second reference video includes:

extracting a first collection of introduction text keywords from an introduction text corresponding to each candidate video, and extracting a second collection of introduction text keywords from an introduction text corresponding to the second reference video; and obtaining the similarity between each candidate video and the second reference video according to the first collection of introduction text keywords and the second collection of introduction text keywords. Optionally, a union of the first collection of introduction text keywords and the second collection of introduction text keywords is acquired, frequencies of keywords in the first collection of introduction text keywords and the second collection of introduction text keywords are calculated, respectively, and the frequencies of keywords in the first collection of introduction text keywords and the second collection of introduction text keywords are subjected to vectorization.

Such a calculation as

$${sim}_{i} = \frac{{\sum }_{j = 1}^{n} ( {c}_{i , j} \times c {e}_{j} )}{\sqrt{{\sum }_{j = 1}^{n} {( {c}_{i , j} )}^{2}} \times \sqrt{{\sum }_{j = 1}^{n} {( c {e}_{j} )}^{2}}}$$

is conducted to obtain a similarity simᵢ between an i-th candidate video and the second reference video; where c_{i,j} is a vector of a frequency of a j-th keyword in the first collection of introduction text keywords corresponding to the i-th candidate video, ceⱼ is a vector of a frequency of a j-th keyword in the second collection of introduction text keywords corresponding to the second reference video, i,j and n are all positive integers, and 1≤j≤n.

Optionally, the step of acquiring a similarity between each candidate video and the second reference video includes:

extracting a first collection of introduction text keywords from a introduction text corresponding to each candidate video, and extracting a second collection of introduction text keywords from a introduction text corresponding to the second reference video; and obtaining the similarity between each candidate video and the second reference video according to the first collection of introduction text keywords and the second collection of introduction text keywords, where, optionally, a union of the first collection of introduction text keywords and the second collection of introduction text keywords is acquired, frequencies of keywords in the first collection of introduction text keywords and the second collection of introduction text keywords are calculated, respectively, and the frequencies of keywords in the first collection of introduction text keywords and the second collection of introduction text keywords are subjected to vectorization; extracting a first collection of comment text keywords from a comment text corresponding to each candidate video, extracting a second collection of comment text keywords from a comment text corresponding to the second reference video, obtaining a union of the first collection of comment text keywords and the second collection of comment text keywords, calculating frequencies of keywords in the first collection of comment text keywords and the second collection of comment text keywords, respectively, and subjecting the frequencies of keywords in the first collection of comment text keywords and the second collection of comment text keywords to vectorization.

Such a calculation

$${sim}_{i} = \frac{\begin{matrix}( {( \frac{{\sum }_{j = 1}^{n} ( {c}_{i , j} \times {ce}_{j} )}{\sqrt{{\sum }_{j = 1}^{n} {( {c}_{i , j} )}^{2} \times } \sqrt{{\sum }_{j = 1}^{n} {( {ce}_{j} )}^{2}}} )}^{2} + {( \frac{{\sum }_{j = 1}^{n} ( {p}_{i , j} \times {pe}_{j} )}{\sqrt{{\sum }_{j = 1}^{n} {( {p}_{i , j} )}^{2} \times } \sqrt{{\sum }_{j = 1}^{n} {( {pe}_{j} )}^{2}}} )}^{2} ) \times \\ \sqrt{{\sum }_{j = 1}^{n} {( {c}_{i , j} )}^{2}} \times \sqrt{{\sum }_{j = 1}^{n} {( {ce}_{j} )}^{2}} \times \sqrt{{\sum }_{j = 1}^{n} {( {p}_{i , j} )}^{2}} \times \sqrt{{\sum }_{j = 1}^{n} {( {pe}_{j} )}^{2}}\end{matrix}}{\begin{matrix}( {\sum }_{j = 1}^{n} ( {c}_{i , j} \times {ce}_{j} ) ) \times \sqrt{{\sum }_{j = 1}^{n} {( {p}_{i , j} )}^{2}} \times \sqrt{{\sum }_{j = 1}^{n} {( {pe}_{j} )}^{2}} + \\ ( {\sum }_{j = 1}^{n} ( {p}_{i , j} \times {pe}_{j} ) ) \times \sqrt{{\sum }_{j = 1}^{n} {( {c}_{i , j} )}^{2}} \times \sqrt{{\sum }_{j = 1}^{n} {( {ce}_{j} )}^{2}}\end{matrix}}$$

is conducted to obtain a similarity simᵢ between an i-th candidate video and the second reference video; where c_{i,j} is a vector of a frequency of a j-th keyword in the first collection of introduction text keywords corresponding to the i-th candidate video, ceⱼ is a vector of a frequency of a j-th keyword in the second collection of introduction text keywords corresponding to the second reference video, p_{i,j} is a vector of a frequency of a j-th keyword in the first collection of comment text keywords corresponding to the i-th candidate video, peⱼ is a vector of a frequency of a j-th keyword in the second collection of comment text keywords corresponding to the second reference video, i,j and n are all positive integers, and 1≤j≤n.

In the above technical solution, the similarities embodied by the introduction and the comment of the video are both considered, and they are combined. Whichever of the introduction and the comment embodies a higher similarity weighs more in simᵢ, so influential factors of both similar comments and similar introductions are well balanced. Therefore, the recommended videos match the interests of the user better or may bring a novel user experience, and thus the user experience concerning the video recommendation is improved.

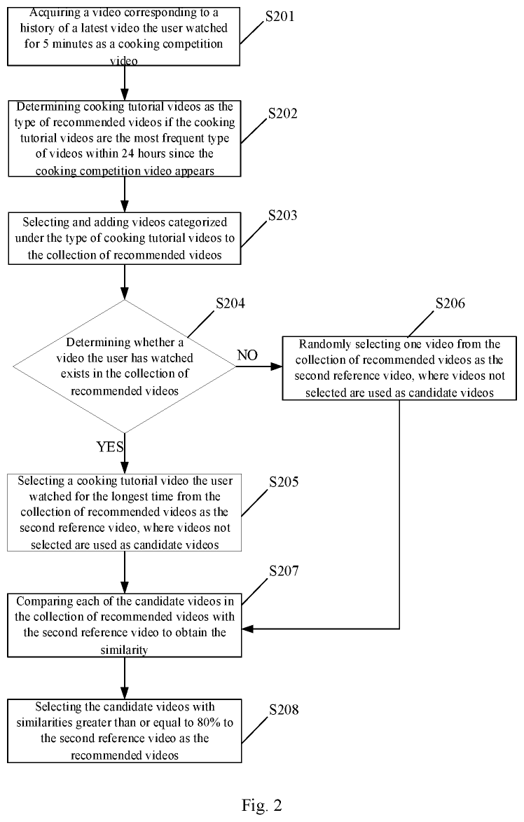

In a practical application, as shown in FIG. 2, which is a flowchart of a method for a user to obtain a video recommendation according to an exemplary embodiment, the method for video recommendation may include the steps of:

step S201, acquiring a video corresponding to a history of a latest video the user watched for 5 minutes as a cooking competition video;

step S202, determining cooking tutorial videos as the type of recommended videos if the cooking tutorial videos are the most frequent type of videos within 24 hours since the cooking competition video appears;

step S203, selecting and adding videos categorized under the type of cooking tutorial videos to the collection of recommended videos;

step S204, determining whether a video the user has watched exists in the collection of recommended videos, if yes, executing step S205, and if not, executing step S206;

step S205, selecting a cooking tutorial video the user watched for the longest time from the collection of recommended videos as the second reference video, where videos not selected are used as candidate videos, and then executing step S207;

step S206, randomly selecting one video from the collection of recommended videos as the second reference video, where videos not selected are used as candidate videos, and then executing step S207;

step S207, comparing each of the candidate videos in the collection of recommended videos with the second reference video to obtain the similarity; and

step S208, selecting the candidate videos with similarities greater than or equal to 80% to the second reference video as the recommended videos.

Optionally, after the recommended video is determined, the recommended video is played on a refrigerator with a screen. The video recommendation is more customized and targeting, so the video played on the refrigerator matches the user requirements better, and the user experience is improved.

A type of recommended videos is determined at first according to a watching history of a user, reference videos can thus be selected from the type of recommended videos, and then recommended videos are determined according to the reference videos, so that the recommended videos are more customized and targeting, matching user requirements and enabling a better user experience.

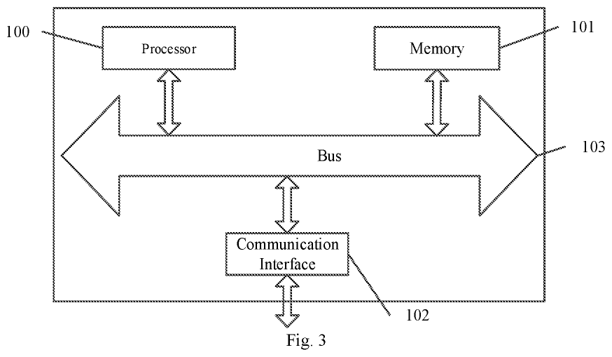

As shown in conjunction with FIG. 3, an embodiment of the present disclosure provides an apparatus for video recommendation that includes a processor 100 and a memory 101 that stores program instructions. Optionally, the apparatus may also include a communication interface 102 and a bus 103. Herein, the processor 100, the communication interface 102, and the memory 101 may communicate with each other via the bus 103. The communication interface 102 may be used for information transmission. The processor 100 may invoke program instructions in the memory 101 to perform the method for video recommendation according to the embodiments described above.

Further, the aforementioned logic instructions in the memory 101 may be stored in a computer-readable storage medium when implemented in the form of software functional units and sold or used as an independent product.

The memory 101 serves as a computer-readable storage medium for storing software programs and computer-executable programs such as program instructions/modules corresponding to the method in the disclosed embodiments. The processor 100 executes functional applications and processes data by running program instructions/modules stored in the memory 101, i.e., implementing the method for video recommendation described in the above embodiments.

The memory 101 may include a storage program partition and a storage data partition, wherein the storage program partition may store an operating system and an application program required for at least one function; the storage data partition may store data or the like created according to the use of the terminal device. Besides, the memory 101 may include a high speed random access memory, and may also include a non-volatile memory.

According to the apparatus for video recommendation provided by the embodiment of the invention, a type of recommended videos is determined at first according to a watching history of a user, reference videos can thus be selected from the type of recommended videos, and then recommended videos are determined according to the reference videos, so that the recommended videos are more customized and targeting, matching user requirements and enabling a better user experience.

An embodiment of the invention provides a refrigerator with a screen including the apparatus for video recommendation as described above.

According to the refrigerator with a screen provided by the embodiment of the invention, a type of recommended videos is determined at first according to a watching history of a user, reference videos can thus be selected from the type of recommended videos, and then recommended videos are determined according to the reference videos, so that the recommended videos are more customized and targeting, matching user requirements and enabling a better user experience.

An embodiment of the present disclosure provides computer-readable storage medium storing computer-executable instructions configured to perform the above-described method for video recommendation.

An embodiment of the present disclosure provides a computer program product including a computer program stored on the computer-readable storage medium, the computer program including program instructions executable by a computer to cause the computer to perform the above-described method for video recommendation.

The computer-readable storage medium may be a transient computer-readable storage medium or a non-transient computer-readable storage medium.

The aspects of the disclosed embodiments may be embodied in the form of a software product stored in a storage medium including one or more instructions for causing a computer device, which may be a personal computer, a server, or a network device, etc., to perform all or part of the steps of the method described in the embodiments of the present disclosure. The storage medium can be a non-transient storage medium, including a variety of media capable of storing program codes, such as a USB flash disk, a mobile hard disk drive, a read-only memory (ROM), a random access memory (RAM), or a magnetic or optical disk; alternatively, the storage medium can be transient storage media.

The foregoing description and drawings illustrate embodiments of the present disclosure sufficiently to enable those skilled in the art to practice them. Other embodiments may include structural, logical, electrical, procedural, and other variations. These embodiments merely represent possible variations. Individual components and functions are optional unless explicitly required otherwise, and the order of operation may vary. Portions and features of some embodiments may be included in other embodiments or replace those of other embodiments. The scope of the embodiments of the present disclosure includes the entire scope of the claims, and all available equivalents thereof As used herein, although the terms “first”, “second”, and the like may describe various elements, these elements should not be limited by these terms. These terms are only used to distinguish one element from another. For example, a first element may be referred to as a second element without changing the meaning of the description, and likewise, a second element may be referred to as a first element, so long as all occurrences of the “first element” are consistently renamed and all occurrences of the “second element” are consistently renamed. The first element and the second element are both elements, but may not be identical elements. Also, the wording herein is used for describing the embodiments only and not intended to limit the claims. As used in the embodiments and the claims, the singular forms of “a”, “an”, and “the” are intended to include the plural forms as well, unless it's clearly indicated otherwise. Similarly, the term “and/or” as used herein is meant to encompass any and all possible combinations of one or more of the associated lists. Additionally, the terms “include” and “comprise”, as well as variations thereof, i.e., “including” and/or “comprising”, when used herein, refer to the presence of stated features, integers, steps, operations, elements, and/or components, but do not preclude presence or addition of one or more other features, integers, steps, operations, elements, components and/or groups. An element defined by the phrase “includes a . . . ” does not, without more constraints, preclude the existence of additional identical elements in the process, method, or device that includes the element. Herein, it is noted that each embodiment differs from another embodiment in their emphases, and they share something in common as the reference for each other. For the method, the product, and the like disclosed in the embodiments, if they correspond to the method disclosed in the embodiments, reference may be made to the corresponding description of the method.

Those skilled in the art will appreciate that the various illustrative units and algorithm steps described in connection with the embodiments disclosed herein may be implemented as electronic hardware, or combinations of computer software and electronic hardware. Whether such functionality is implemented as hardware or software depends upon the particular application and design constraints imposed on the particular implementation. Those skilled in the art may implement the described functionality in varying ways for each particular application, but such an implementation should not be interpreted as causing a departure from the scope of the disclosed embodiments. It will be apparent to those skilled in the art that, for convenience and brevity of description, reference may be made to corresponding processes in the foregoing method embodiments for specific operation of the system, apparatus and unit described above, which will not be described in detail herein.

In the embodiments disclosed herein, the disclosed method, article of manufacture (including, but not limited to, apparatus, device, etc.) may be implemented otherwise. For example, the apparatus embodiments described above are merely illustrative, e.g., the partitioning of unit may be only based on the logical function, and additional ways of partitioning may be possible in an actual implementation, doe example, multiple units or components may be combined or integrated into another system, or some features may be omitted or not performed. Besides, the couplings or direct couplings or communicative connections shown or discussed with respect to one another may be indirect couplings or communicative connections through some interface, device or unit, and may be electrical, mechanical or otherwise. The units described as separate components may or may not be physically separate, and the components shown as units may or may not be physical units, in other words, they may have a single location, or may be a plenty of units distributed over a network. Some or all of the units may be selected as necessary to implement the embodiments herein. Moreover, the functional units in the embodiments of the present disclosure may be integrated in one processing unit, may be separate physical units, or may be integrated in one unit with two or more units.

The flowcharts and block diagrams in the drawings illustrate the architecture, functionality, and operation of possible implementations of the system, method, and computer program product in accordance with embodiments of the present disclosure. In this regard, each block in the flowchart or block diagram may represent a module, a segment, or a portion of codes, which includes one or more executable instructions for implementing the specified logical function(s). In some alternative implementations, the functions noted in the blocks may take place in a different order from that noted in the drawings. For example, two successive blocks may in fact be executed substantially in parallel, and they may sometimes be executed in the reverse order, depending upon the functionality involved. In the description of the flowcharts and block diagrams in the drawings, the operations or steps corresponding to different blocks may also occur in a different order from that disclosed in the description, sometimes without a particular order between the different operations or steps. For example, two successive operations or steps may in fact be performed substantially in parallel, and they may sometimes be performed in the reverse order, depending on the functionality involved. Each block of the block diagrams and/or flowcharts, and combinations of blocks in the block diagrams and/or flowcharts, can be implemented by special purpose hardware-based systems which perform the specified functions or acts, or implemented by combinations of special purpose hardware and computer instructions.

1. A method for video recommendation, comprising:
determining a first reference video according to a watching history of a user;
determining a collection of recommended videos according to the first reference video;
selecting a second reference video from the collection of recommended videos, where videos not selected in the collection of recommended videos are used as candidate videos; and
determining recommended videos according to the similarity between the candidate videos and the second reference video.

2. The method according to claim 1, wherein the step of determining a collection of recommended videos according to the first reference video comprises:
determining a type of recommended videos according to the first reference video;
determining the collection of recommended videos according to the type of recommended videos.

3. The method according to claim 1, wherein the watching history comprises:
a history of a latest video a user watched; or
a history of a latest video the user watched for a duration reaching a set threshold value; or
a history of a video the user watched most frequently.

4. The method according to claim 2, wherein the step of determining a type of recommended videos according to the first reference video comprises:
determining a most frequent type of videos in a set timeframe since the first reference video appears as the type of recommended videos.

5. The method according to claim 2, wherein the step of determining a collection of recommended videos according to the type of recommended videos comprises:
adding videos corresponding to the type of recommended videos to the collection of recommended videos.

6. The method according to claim 1, wherein the step of selecting a second reference video from the collection of recommended videos comprises:
selecting a video the user watched for the longest time from the collection of recommended videos as the second reference video, where videos not selected from the collection of recommended videos are used candidate videos; or
randomly selecting one video from the collection of recommended videos as the second reference video, where videos not selected from the collection of recommended videos are used candidate videos.

7. The method according to claim 1, wherein the step of determining recommended videos according to the similarity between the candidate videos and the second reference video comprises:
acquiring a similarity between each candidate video between the second reference video;
selecting a candidate video with a maximum similarity to the second reference video as a recommended video; or
selecting a candidate video with a minimum similarity to the second reference video as a recommended video; or
selecting a candidate video with a similarity in a set range to the second reference video as a recommended video.

8. The method according to claim 7, wherein the step of acquiring a similarity between each candidate video between the second reference video comprises:
extracting a first collection of keywords from an introduction text of each candidate video, and extracting a second collection of keywords from the introduction text of the second reference video; and
obtaining the similarity between each candidate video and the second reference video according to the first collection of keywords and the second collection of keywords.

9. An apparatus for video recommendation comprising a processor and a memory storing program instructions, wherein the processor is configured to perform the method for video recommendation according to claim 1 when executing the program instructions.

10. A refrigerator with a screen, comprising the apparatus for video recommendation according to claim 9.

11. An apparatus for video recommendation comprising a processor and a memory storing program instructions, wherein the processor is configured to perform the method for video recommendation according to claim 2 when executing the program instructions.

12. An apparatus for video recommendation comprising a processor and a memory storing program instructions, wherein the processor is configured to perform the method for video recommendation according to claim 3 when executing the program instructions.

13. An apparatus for video recommendation comprising a processor and a memory storing program instructions, wherein the processor is configured to perform the method for video recommendation according to claim 4 when executing the program instructions.

14. An apparatus for video recommendation comprising a processor and a memory storing program instructions, wherein the processor is configured to perform the method for video recommendation according to claim 5 when executing the program instructions.

15. An apparatus for video recommendation comprising a processor and a memory storing program instructions, wherein the processor is configured to perform the method for video recommendation according to claim 6 when executing the program instructions.

16. An apparatus for video recommendation comprising a processor and a memory storing program instructions, wherein the processor is configured to perform the method for video recommendation according to claim 7 when executing the program instructions.

17. An apparatus for video recommendation comprising a processor and a memory storing program instructions, wherein the processor is configured to perform the method for video recommendation according to claim 8 when executing the program instructions.
